(19) United States
(12) Patent Application Publication
(10) Pub. No.: US 2007/0024650 A1
(43) Pub. Date: Feb. 1, 2007

(54) Method of improved controlling of an ink jet printer, and ink jet printer

(75) Inventors: Hans Reinten, Velden (NL); Peter G.F. Theuws, Geldrop (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/492,070

(22) Filed: Jul. 25, 2006

(30) Foreign Application Priority Data
Jul. 26, 2005 (EP) 05106849.2

(51) Int. Cl. B41J 29/38

(52) U.S. Cl. 347/9

(57) ABSTRACT

A method for improved controlling of an ink jet printer includes measuring the amount of ink dosed to at least one printhead of the ink jet printer, measuring the amount of ink droplets released by at least one nozzle of the printhead, and determining the amount of a ink contained by the printhead by using the amounts measured. A computer program and a computer running the computer program are adapted to carry out the method. Moreover, an ink jet printer is adapted to perform the method.

### CROSS-REFERENCE TO RELATED APPLICATIONS

This nonprovisional application claims priority under 35 U.S.C. § 119(a) on Patent Application No. 05106849.2, filed in Europe on Jul. 26, 2005, the entirety of which is incorporated herein by reference.

### BACKGROUND OF THE INVENTION

1. Field of the Invention

The present invention relates to a method for improved controlling of an ink jet printer. The present invention also relates to a computer program adapted for carrying out the method according to the invention. The present invention further relates to a computer running the computer program according to the invention. Moreover, the present invention relates to an ink jet printer adapted to perform the method according to the invention.

2. Description of Background Art

It is known in the background art to apply an ink level sensor for an ink jet printer within an ink reservoir of a printhead to detect the ink level when it exceeds a certain threshold level. The information gathered by the ink level sensor is used to determine, among other things, the amount of ink to be dosed to the ink reservoir within a certain timeframe. This situation is far from optimal due to a lack of accuracy of the ink level sensor. Specifically, the sensor is merely adapted to perform a small range detection, only a certain (and single) threshold level can be detected when exceeded, and accurate detection of the ink level sensor is hindered due to thermal inertia of the sensor. Moreover, the accuracy of the ink level sensor is also dependent on situational circumstances, such as thermal conditions of the printhead, the local environment and the isolation between the ink level sensor and other parts of the printhead. Besides a relatively poor accuracy of the ink level sensor, the known method of determining the amount of ink to be dosed is not optimal, since the level in the ink reservoir is not the same as the total amount of ink within the printhead. Specifically, in a productive application there may be a significant portion of ink on its way from being melted (if a hot melt ink is used), flowing down, passing an ink filter and a valve to finally add this ink portion (not noticed by the ink level sensor) to the reservoir.

### SUMMARY OF THE INVENTION

It is an object of the present invention to provide an improved method for controlling an ink jet printer.

This object can be achieved according to a first aspect of the present invention by providing a method for improved controlling of an ink jet printer, comprising the steps of: A) measuring the amount of ink dosed to at least one printhead of said ink jet printer; B) measuring the amount of ink droplets released by at least one nozzle of said printhead; and C) determining the amount of ink contained in the printhead using the amounts determined in steps A) and B).

By generating a balance of matter, in particular an ink balance, of the printhead as a system with an inlet for ink (ink dosed to the printhead), an outlet for ink (ink released via the nozzle(s)), and an ink container (formed by the printhead itself), different parameters can be obtained during a period of time. Improved controlling of the jetting process of the ink jet printer can be obtained, based upon the relevant information gained from the different parameters. This improved controlling of the jetting process may imply, e.g. improved knowledge in relation to color management during the jetting process.

According to a second aspect of the present invention, the method for improved controlling of an ink jet printer further comprises step D) of determining the amount of ink to be dosed to the printhead based upon the amount of ink contained by the printhead determined during step C).

By considering the printhead as such as a system to which a balance of ink is applied, the amount of ink to be dosed for one or more planned printed tasks can be calculated relatively timely and accurately with respect to dosing of ink based upon information gathered by a conventional ink level sensor. This relatively accurate controlling of the amount of ink, preferably though not exclusively formed by ink pellets (or ink pills), to be dosed during operation of the ink jet printer will lead to a significantly improved control of the ink jet printer, and in particular of the jetting process of the printer.

To be able to apply the method according to the present invention, the size (volume) of the droplets released by the nozzle(s) are assumed to be known. Determination of the droplet size can be realized in different manners. To this end, the droplet size may be determined, e.g. by means of a balance of matter, a camera, et cetera.

As mentioned above, ink is preferably dosed to the printhead in the form of ink pellets. In a preferred embodiment, during step A) the amount of ink dosed to the printhead is measured by counting the number of ink pellets dosed to the printhead, each pellet having a substantially predetermined and identical volume. In this manner, the ink supply to the printhead can be controlled and dosed relatively accurately. The ink pellets are preferably formed by hot melt ink, id est an ink which is solid at room temperature but liquid at elevated temperature. For this purpose, the ink is firstly heated in the inkjet printhead to a temperature at which it is liquid, id est has a consistency such that it can be ejected in the form of small drops by means of the printhead.

Measuring the amount of ink released by the nozzle(s) of the printhead according to step B) is preferably measured by counting the number of ink droplets released. To this end, preferably a droplet counter is provided to count the number of ink droplets expelled from the ink reservoir via the nozzles.

In a preferred embodiment, the method for improved controlling of an ink jet printer further comprises step E) of measuring the number of pressure pulses, in particular activation pulses, to selectively expel the ink droplets via the nozzle, wherein according to step C) the amount of a ink contained by the printhead is based upon measured values gathered in steps A), B) and E). By measuring the number of pressure pulses, in particular activation pulses, an indication can be obtained of the number of ink droplets released by the nozzle(s), which commonly extends, and hence improves the balance of matter, in particular the balance of ink, of the ink jet printer. Waste-ink created by purging and cleaning the ink reservoir can be compensated for in the method according to the invention, for example by resetting reference values before actually monitoring the printing process, and in particular the jetting process.

There are two basic propulsion techniques for drop-on-demand ink jet printers. One uses a piezoelectric transducer to produce pressure pulses selectively to expel the droplets and the other technique uses thermal energy, usually the momentary heating of a resistor, to produce a vapor bubble in the ink, which during its growth expels a droplet. Either technique uses ink-filled channels or passageways, which interconnect an orifice or nozzle and an ink-filled manifold. The pressure pulse may be generated anywhere in the channels or the manifold. However, the bubble generating resistor (hence the name bubble jet) must be located in each channel near the nozzle.

Inter alia, to be able to calibrate the measured values gathered with the method according to the present invention, the method for improved controlling of an ink jet printer preferably further comprises step F) of measuring an ink level within at least one ink reservoir of the printhead. Calibration of the printhead to which the method is applied can be performed on a long term time scale by measuring the ink level within the ink reservoir. To optimize the reliability of reference values to be obtained by the (hardware) ink level sensor for calibration of the printhead, preferably measurements by the ink level sensor are taken which are performed under relatively stable conditions, wherein the uncertainty in the ink level sensor is relatively small. To this end, reference values may be obtained, e.g. by not moving a carriage carrying the printhead for more than approximately 30 seconds since the last ink pill was dosed with the carriage positioned at a well-defined position under well-defined thermal conditions. The ink level within the ink reservoir can be detected by means of different kinds of sensors such as a float level indicator, electrical resistance, and a thermal sensor. Though preferably during step F) the ink level within the ink reservoir is measured by means of at least one thermistor, more preferably an NTC thermistor. Application of an NTC thermistor is relatively inexpensive with respect to the application of other types of thermal sensors. However, under specific circumstances it could also be conceivable for a person skilled in the art to apply a PTC type thermistor, or even other kinds of temperature sensitive (electronic) detecting means.

During step C), preferably a control unit is used for determining the amount of ink contained in the printhead. The control unit may be programmed to (automatically) adjust the amount of ink (pellets) to be dosed to the printhead to secure sufficient (and no excess) supply of ink to perform certain printing tasks. Commonly, this control unit will be a software embedded module, wherein the software is adapted to perform the method according to the present invention.

As aforementioned, the ink dosed to the printhead is preferably formed by hot melt pellets. To melt these ink pellets and to keep these pellets in a molten state within the ink reservoir(s) of the printhead, the ink within the ink reservoir(s) is preferably heated. In this manner, the ink contained within the ink reservoir(s) can be kept easily at an elevated temperature typically of about 130° Celsius.

The present invention also relates to a computer program adapted for carrying out the method according to the invention. In this manner, the amount of ink contained by the printhead (step C)) can be determined by the computer program acting as a software level sensor. The computer program is preferably also suitable to determine the amount of ink, in particular the number of ink pellets, to be dosed to the printhead based on the information gathered under step C). The computer program may be embedded within the ink jet printer.

The present invention further relates to a computer running the computer program according to the invention. This computer may form part of the ink jet printer according to the invention. The aforementioned control unit may be an integral part of the computer.

Moreover, the present invention relates to an ink jet printer adapted for performing the method according to the invention, comprising: at least one printhead, including: a plurality of nozzles; and ink channels arranged side by side, each nozzle being connected to an ink reservoir via its associated ink channel; and a device for dispensing ink pellets of substantially predetermined and identical volume to the printhead, wherein the ink jet printer further comprises a first counting mechanism that counts the number of ink pellets dispensed to the printhead, a second counting mechanism that counts the number of ink droplets released by the nozzles, and a control that determines the amount of ink contained by the printhead based upon measured values gathered by the first counting mechanism and the second counting mechanism.

As aforementioned, the total amount of ink contained by the printhead can be determined by making up a balance of matter, in particular a balance of ink, as a result of which the process for dosing ink (pellets) to the printhead can be optimized relatively easily though accurately. To be able to calibrate these mechanisms from time to time, it is advantageous that the ink jet printer further comprises a detector, in particular one or more ink level sensors, that detect the ink level within each ink reservoir. To be able to make a realistic assessment of the release of ink by the printhead, the second counting mechanism is preferably adapted to count the number of pressure pulses, in particular activation pulses, produced to expel the ink droplets via the nozzles.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of an ink jet printer according to an embodiment of the present invention.

### DETAILED DESCRIPTION OF THE PREFERRED EMBODIMENTS

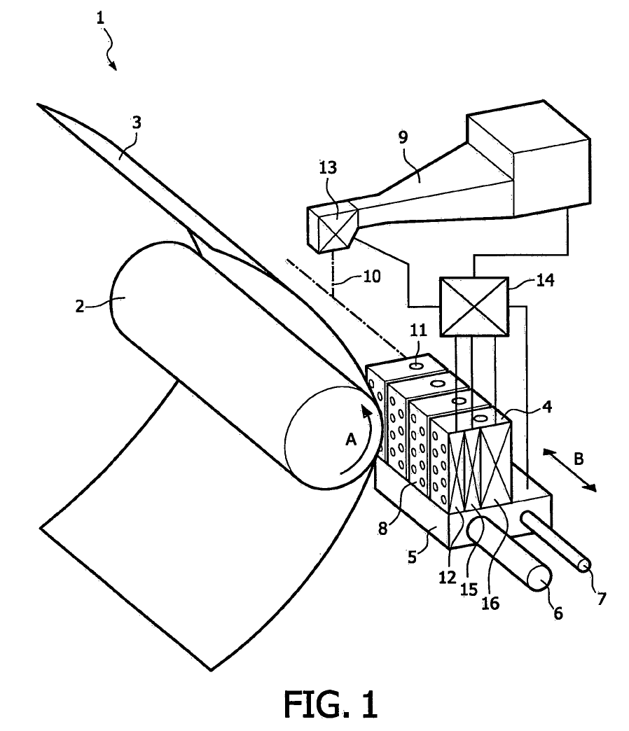

FIG. 1 is a perspective view of an ink jet printer 1 according to an embodiment of the present invention. In this embodiment the printer 1 includes a roller 2 to support a substrate 3 and move it along the four printheads 4. The roller 2 is rotatable about its axis as indicated by arrow A. A carriage 5 carries the four printheads 4 and can be reciprocated in the direction indicated by the double arrow B, parallel to roller 2. In this way, the printheads 4 can scan the receiving substrate 3, for example a sheet of paper. The carriage 5 is guided over rods 6 and 7 and is driven by means suitable for the purpose (not shown). In the embodiment shown in this figure, each printhead 4 contains eight ink reservoirs (not shown) connected to eight ink ducts, each with its own nozzle 8, which form two rows of four nozzles 8 each perpendicular to the axis of the roller 2. In a practical embodiment of the printer 1, the number of ink ducts per printhead 4 and the number of nozzles per printhead will be many times greater. Each ink duct is provided with a mechanism for energizing the ink duct (not shown) and an associated electric actuation circuit (not shown). In this way, the ink duct, the said mechanism for energising the ink duct, and the actuation circuit form a unit which can serve to eject ink drops in the direction of roller 2. If the ink ducts are energized image-wise, an image is formed from build up of ink drops on the substrate 3.

When a substrate is printed with a printer 1 of this kind in which ink drops are ejected from ink ducts, the substrate, or part thereof, is (imaginarily) divided into fixed locations which form a regular field of pixel rows and pixel columns. In one embodiment, the pixel rows are perpendicular to the pixel columns. The resulting separate locations can each be provided with one or more ink drops. The number of locations per unit of length in the directions parallel to the pixel rows and pixel columns is termed the resolution of the printed image, and is indicated, for example, as 400×600 d.p.i. (“dots per inch”). By image-wise energization of a row of nozzles of the printhead of the printer when it moves over a strip of the substrate 3 in a direction substantially parallel to the pixel rows, the row of nozzles being substantially parallel to the pixel columns, as shown in this figure, an image built up from ink drops forms on the substrate 3.

In this embodiment, the printer 1 is provided with a number of dispensing devices 9, one for each color, only one being shown in this figure for simplification. With a dispensing device of this kind it is possible to dispense ink pellets at each of the printheads 4.

The ink used is a hot melt ink. An ink of this kind is solid at room temperature and liquid at elevated temperature. This ink is dispensed in solid form in each of the printheads whereafter the ink in the printhead is melted and is brought to operating temperature, typically 130° Celsius. As soon as there is a shortage of liquid ink in one of the printheads, the carriage 5 will be so moved that the relevant printhead is disposed beneath the corresponding dispensing device level with dispensing line 10. One or more ink pellets will then be dispensed to the printhead, the pellets entering the printhead via opening 11. These pellets are then melted and brought to operating temperature.

To prevent a shortage of ink in the printheads 4, and to enable timely supply of ink to the printheads 4, the printer 1 includes a counter 12 for counting the number of ink droplets released by the nozzles 8, and a counter 13 for counting the number of ink pellets dispensed. Based on the information provided by both counters 12, 13 the amount of ink contained by the printheads 4 can be determined and subsequently the number of ink pellets to be dosed to the printheads 4 can be calculated. These determinations will commonly be realized by a computer program embedded within a control unit 14. In this manner, timely and sufficient supply of ink to the printheads 4 can be secured.

To optimize the determination of the amount of ink contained by the printheads 4, the printer 1 preferably also includes a counter 15 for counting the number of drive pulses produced to determine to the number of ink droplets released by the printheads 4. An ink level sensor 16 is provided to gather reference values with which the software sensor can be calibrated.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for controlling an ink jet printer, comprising the steps of:
A) measuring the amount of ink dosed to at least one printhead of said ink jet printer;
B) measuring the amount of ink droplets released by at least one nozzle of said printhead; and
C) determining the amount of a ink contained by the printhead by using the amounts determined in steps A) and B).

2. The method according to claim 1, further comprising step D) of determining the amount of ink to be dosed to the printhead based upon the amount of ink contained by the printhead determined during step C).

3. The method according to claim 1, wherein during step A), the amount of ink dosed to the printhead is measured by counting the number of ink pellets dosed to the printhead, each pellet having a substantially predetermined and identical volume.

4. The method according to claim 1, wherein during step B), the number of ink droplets released by the at least one nozzle of the printhead is measured by counting the number of ink droplets released.

5. The method according to claim 1, further comprising step E) of measuring the number of pressure pulses to selectively expel the ink droplets via the nozzle,
wherein according to step C), the amount of ink contained by the printhead is based upon measured values gathered in steps A), B) and E).

6. The method according to claim 1, further comprising step F) of measuring an ink level within at least one ink reservoir of the printhead.

7. The method according to claim 6, wherein during step F), the ink level within the ink reservoir is measured by at least one thermistor.

8. The method according to claim 1, wherein during step C), a control unit is used to determine the amount of ink contained by the printhead.

9. The method according to claim 1, wherein the ink contained by the printhead is heated.

10. A computer program embodied on a computer readable memory, said computer program being adapted to perform a method for controlling an ink jet printer, comprising the steps of:
A) measuring the amount of ink dosed to at least one printhead of said ink jet printer;
B) measuring the amount of ink droplets released by at least one nozzle of said printhead; and
C) determining the amount of a ink contained by the printhead by using the amounts determined in steps A) and B).

11. A computer for running the program embodied on a computer readable memory according to claim 10.

12. An ink jet printer comprising:
at least one printhead, said at least one printhead including:
a plurality of nozzles; and
ink channels arranged side by side, each of said plurality of nozzles being connected to an ink reservoir via an ink channel, respectively;
a device that dispenses ink pellets of substantially predetermined and identical volume to the printhead;
a first counting mechanism that counts the number of ink pellets dispensed to the printhead;
a second counting mechanism that counts the number of ink droplets released by the nozzles; and
a control that determines the amount of ink contained in the printhead based upon measured values gathered by the first counting mechanism and the second counting mechanism.

13. The ink jet printer according to claim 12, further comprising a detector that detects an ink level within each ink reservoir.

14. The ink jet printer according to claim 12, wherein the second counting mechanism is adapted to count the number of pressure pulses produced to expel the ink droplets via the nozzles.

15. The ink jet printer according to claim 12, wherein the control determines the amount of ink to be dosed to the printhead by the device that dispenses ink pellets based upon the amount of ink contained in the printhead.

16. The ink jet printer according to claim 13, wherein the detector is at least one thermistor.

17. The ink jet printer according to claim 13, further comprising a heater that heats the ink contained in the printhead.
